(19) United States
(12) Patent Application Publication
(10) Pub. No.: US 2003/0201961 A1
(43) Pub. Date: Oct. 30, 2003

(54) Projection system and method for reflection-type liquid crystal display

(76) Inventor: Ki-Hyung Kang, Suwon-city (KR)

Correspondence Address: Robert E. Bushnell, Suite 300, 1522 K Street, N.W., Washington, DC, 20005, US

(21) Appl. No.: 10/338,910

(22) Filed: Jan. 9, 2003

(30) Foreign Application Priority Data
Apr. 24, 2002 (KR) 2002-22530

(51) Int. Cl. G09G 3/36

(52) U.S. Cl. 345/88

(57) ABSTRACT

Disclosed are a projection system and method for a reflection-type liquid crystal display (LCD). The projection method of the reflection-type LCD includes the steps of selectively transmitting a beam in white light, sequentially converting the selectively transmitted beam into R/G/B light and dividing the converted light into an S-polarization beam and a P-polarization beam, a reflection-type LCD receiving the polarized beam and driving liquid crystal for each pixel to thus realize a screen and enlarging the thus realized image and projecting the enlarged image to the screen through a projection lens system, and applying a reset voltage to the reflection-type LCD and forcibly displaying an entire screen to be black before displaying the next screen when a screen is displayed. It is possible to improve the brightness of an entire system by providing a reset state where the reflection-type LCD driven in a white mode in a normal state among single panel reflection-type LCDs displays an entire screen to be black before displaying the screen. It is possible to reduce an off-time which is a problem in the white mode because a panel that operates in the white mode in the normal state operates like a panel that operates in a black mode in the normal state. Accordingly, it is possible to improve light efficiency and to reduce light leakage.

### CLAIM OF PRIORITY

This application makes reference to, incorporates the same herein, and claims all benefits accruing under 35 U.S.C. §119 from an application for SYSTEM FOR PROJECTION OF LIQUID CRYSTAL ON SILICON AND METHOD THEREOF earlier filed in the Korean Industrial Property Office on Apr. 24, 2002 and there duly assigned Serial No. 2002-22530.

### BACKGROUND OF THE INVENTION

1. Field of the Invention

The present invention relates to a reflection-type liquid crystal display (LCD). More specifically, the present invention relates to a projection system and method for a reflection-type LCD for improving the entire brightness by removing shortcomings of a normally white mode in a normal state in a single panel liquid crystal on silicon (LCOS) system.

2. Description of the Related Art

A liquid crystal display (LCD) referred to as a single panel liquid crystal on silicon (LCOS), is a flat plate display. The LCOS is light, has high resolution, and consumes less power than a common LCD. Also, it is possible to reduce expenses for manufacturing panels thereof. Therefore, the LCOS is gradually becoming popularized over a cathode ray tube. The LCOS is formed to realize a micro display.

The LCOS is formed by arranging a liquid crystal material between a semiconductor rear substrate and a front glass substrate and operates through reflection.

In the LCOS, because cells are formed on a semiconductor substrate, unlike a common LCD, it is possible to easily arrange a driving circuit according to a matrix method, and elements of each pixel. Accordingly, it is possible to miniaturize the LCOS, unlike other apparatuses.

In general, a single panel LCOS system includes an illuminating system for projecting a beam, a color splitting device for dividing white light into red (R)/green (G)/blue (B), a polarizing beam splitter (PBS) for splitting a beam according to polarization, and a projection system for irradiating an image into an LCOS panel and a screen.

FIG. 1 shows the driving waveform and the output light of an LCOS panel driven in a white mode in a normal state according to an embodiment of a conventional technology.

As shown in FIG. 1, because the LCOS panel driving in the white mode in the normal state is initially white, a time (tₒₙ) spent on displaying a signal and a time (t_{off}) spent on returning to an initial state after displaying the signal exist.

Therefore, because leaking light exists regardless of signals during the time (t_{off}), the color split device must cut off a beam.

Because the main characteristics of the LCOS panel are contrast and brightness, a brighter white state and a darker black state must be able to be displayed. Because the LCOS panel driven in the white mode in a normal state lacks a time for turning on the color split device, the brightness thereof is lower than in the LCOS panel driven in a normally black mode in a normal state.

### SUMMARY OF THE INVENTION

It is therefore an object of the present invention to provide a projection system and method for a reflection-type liquid crystal display (LCD), which is capable of improving brightness by providing a reset state where a reflection-type LCD driven in a white mode in a normal state among single panel reflection-type LCDs displays an entire screen to be black before displaying the screen.

It is another object to provide a projection system and method that improves light efficiency and reduces light leakage.

It is yet another object to provide a projection system and method that reduces an off-time that is a problem in the white mode because a panel that operates in the white mode in the normal state operates like a panel that operates in the black mode in the normal state.

In order to achieve the above and other objectives, the preferred embodiments of the present invention provides in one aspect of the present invention, a projection system of a reflection-type liquid crystal display (LCD), including an illuminating system for selectively transmitting a polarized beam stabilized to be suitable for a wavelength band and a wavelength direction required for displaying a color image in white light emitted by a light source; a color split device for sequentially converting the beam selectively transmitted by the illuminating system into red (R)/green (G)/blue (B) light; a polarizing beam splitter (PBS) for transmitting the beam converted by the color split device and dividing the beam into an S-polarization beam and a P-polarization beam; a reflection-type LCD, which is driven in synchronization with the color split device after displaying a screen and where a reset voltage forcibly displaying an entire screen to be black is modulated and applied to a common electrode, the reflection-type LCD for receiving the beam polarized by the PBS and driving liquid crystal for each pixel to thus realize a screen; and a projection lens system for enlarging an image realized by the reflection-type LCD and projecting the image to a screen.

The reflection-type LCD displays a black screen before displaying a screen by a reset voltage increasing a turn-on time of the color split device. The reflection-type LCD, to which a reset voltage no less than a saturation voltage is applied, displays a reset state and a display state.

In another aspect of the present invention, there is provided a projection method of a reflection-type LCD, the method including (a) selectively transmitting a polarized beam stabilized to be suitable for a wavelength band and a wavelength direction required for displaying a color image in white light emitted by a light source, (b) sequentially converting the beam selectively transmitted in the step (a) into R/G/B light and dividing the converted light into an S-polarization beam and a P-polarization beam, (c) a reflection-type LCD receiving the beam polarized in the step (b) and driving liquid crystal for each pixel to thus realize a screen and enlarging the thus realized image and projecting the enlarged image to screen through a projection lens system, and (d) applying a reset voltage to the reflection-type LCD and forcibly displaying an entire screen to be black before displaying the next screen when a screen is displayed in the step (c).

The reset voltage applied to the reflection-type LCD in the step (c) is no less than a saturation voltage so that the reflection-type LCD can display a reset state and a display state after an initial state.

The reset voltage applied to the reflection-type LCD in the step (c) controls a time spent on converting the beam into the R/G/B lights in the step (b).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows the driving waveform and the output light of a liquid crystal on silicon (LCOS) panel driving in a white mode in a normal state according to an earlier art;

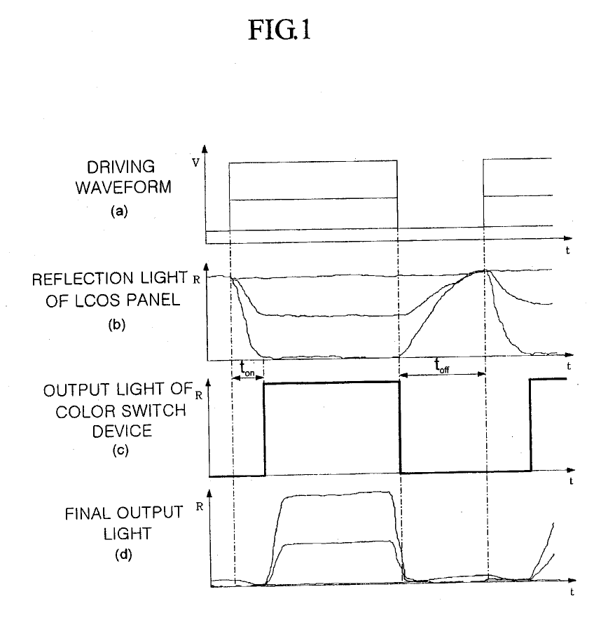

FIG. 2 shows a structure of a common single panel LCOS system;

FIG. 3 is a flowchart showing a projection method of a reflection-type liquid crystal display (LCD) according to an embodiment of the present invention;

FIG. 4 shows the driving waveform and the output light of an LCOS panel driven in a white mode in a normal state according to an embodiment of the present invention; and

FIG. 5 shows a graph of a light throughput in each mode when a response characteristic of the reflection-type LCD is assumed to be linear.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

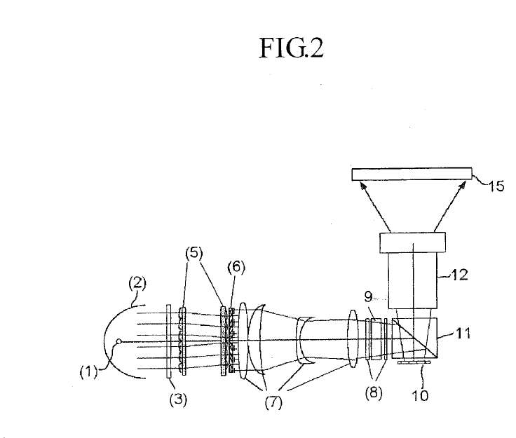

FIG. 2 shows a structure of a common single panel liquid crystal on silicon (LCOS) system.

As shown in FIG. 2, the single panel LCOS system provides white light emitted by a light source 1 to a LCOS panel 10 through an optical filter 3, a plurality of optical lenses, and a polarizing beam splitter 11, and realizes an image by enlarging an image realized by the LCOS panel 10 and projecting the image to a screen 15 through a projection lens system 12.

At this time, the light source 1 includes a parabola-shaped reflection plate 2 so that a beam emitted by the light source 1 is intensively projected to the optical filter 3. The optical filter 3 intercepts infrared light and ultraviolet (UV) rays among beams received from the light source 1 and selectively transmits a beam in a range of a visible ray.

A pair of condensing lenses 5 and a polarization conversion system (PCS) 6 are positioned in front of the optical filter 3. The PCS 6 converts an unstable polarized beam emitted by the light source into a stable polarized beam advantageous to the driving of the LCOS panel 10.

Focusing lenses 7 positioned in front of the PCS 6 refract a beam that passes through the PCS 6 and focuses the beam on polarization plates 8. The polarization plates 8 selectively transmit a beam that vibrates in the same direction as the direction of a polarization axis thereof. A color split device 9 arranged between the polarization plates 8 and the PBS 11 sequentially divides white light emitted by the light source into R/G/B light and provides the R/G/B light to the LCOS panel 10.

The PBS 11 divides a beam received from the color split device 9 and the polarization plates 8 into an S-polarization beam and a P-polarization beam, and provides the S-polarization beam whose reflection efficiency is commonly excellent, to the LCOS panel 10.

The LCOS panel 10 receives the polarized beam and drives liquid crystal of each pixel, to thus realize a screen. A beam that passes through and is reflected from the LCOS panel 10 is incident on the PBS 11. An image that passes through the PBS 11 is enlarged and projected to a screen 15 through a projection lens system 12 obtained by combining a plurality of lenses with each other.

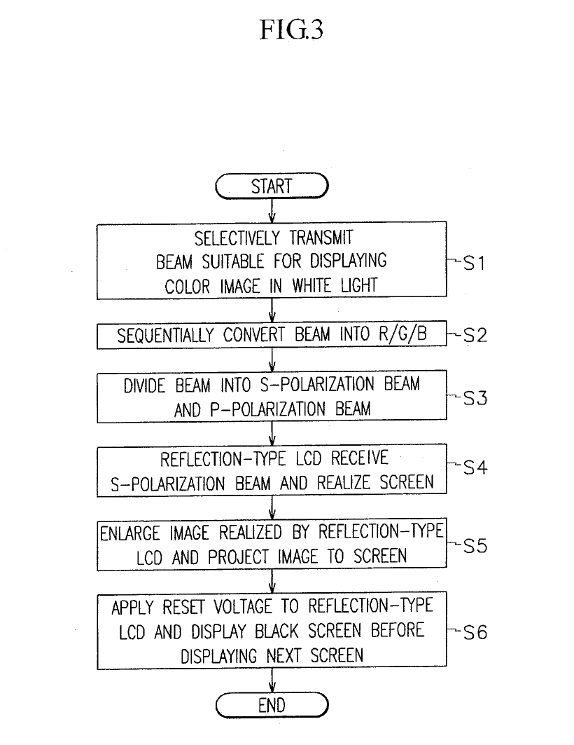

FIG. 3 is a flowchart showing a projection method for a reflection-type liquid crystal display (LCD) according to an embodiment of the present invention.

As shown in FIG. 3, in the projection method for the reflection-type LCD according to the embodiment of the present invention, an illuminating system selectively transmits a polarized beam stabilized to be suitable for a wavelength band and a wavelength direction, which are required for displaying a color image, in white light emitted by the light source (step S1).

The illuminating system includes a reflection mirror, the optical filter, the condensing lens, the PCS, the focusing lens, and the polarization plate. The illuminating system selectively transmits a beam of a visible ray wavelength band excluding the UV rays and the infrared light in the white light and converts the unstable polarized beam into the stable polarized beam. The illuminating system arranged on a light path selectively transmits a beam of a specific polarization axis.

The color split device sequentially converts the beam selectively transmitted by the illuminating system into R/G/B light (step S2). The PBS receives the beam converted by the color split device and divides the beam into the S-polarization beam and the P-polarization beam (step S3).

The reflection-type LCD receives the beam polarized by the PBS, drives liquid crystal for each pixel, and realizes a screen (step S4). The projection lens system enlarges the image realized by the reflection-type LCD and projects the image to a screen (step S5).

At this time, the reflection-type LCD displays a black screen before displaying the next screen, because a reset voltage for forcibly displaying an entire screen to be black is modulated and applied to a common electrode after displaying a screen (step S6). The excess current is applied to the common electrode.

Therefore, because the reflection-type LCD displays a reset state and a display state after the initial state, the reflection-type LCD driven in the white mode in the normal state is driven like a panel driven in a black mode in the normal state.

The reflection-type LCD is formed of an LCOS panel where a semiconductor integrated circuit and a driving circuit, which are switching devices, are formed on a semiconductor lower substrate, and an upper substrate is integrally combined with the semiconductor lower substrate with an intervening liquid crystal layer.

A transparent electrode such as an indium tin oxide (ITO) film is formed on one surface of an upper substrate that faces the liquid crystal layer. A reflection electrode such as an aluminum film is formed on one surface of the semiconductor lower substrate that faces the upper substrate for each pixel. The transparent electrode and the reflection electrode are combined with each other and the resultant pixel. The transparent electrode and the reflection electrode function as the common electrode and a pixel electrode, respectively.

The above-mentioned reset voltage that is a voltage of no less than a saturation voltage is preferably applied to the common electrode of the reflection-type LCD.

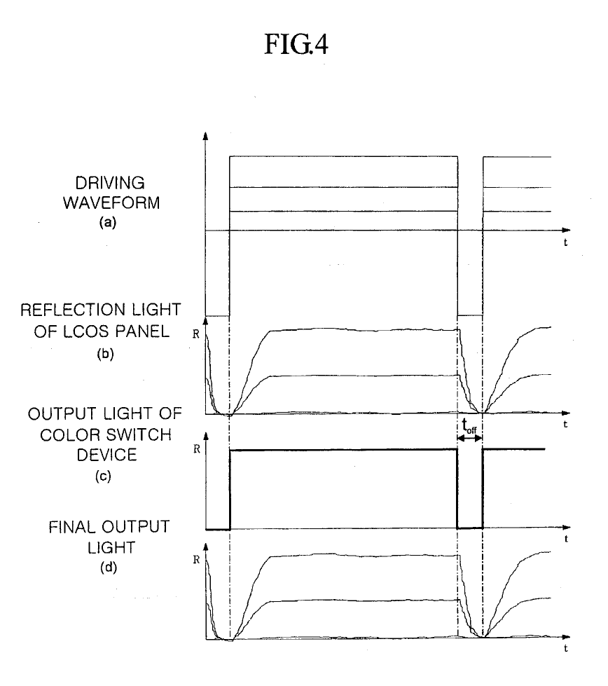

FIG. 4 shows the driving waveform and the output light of the LCOS panel driven in the white mode in the normal state according to an embodiment of the present invention.

As shown in FIG. 4, a time t_{off} spent on the reflection-type LCD displaying a screen and returning to an initial state is reduced to less than in a conventional technology. Therefore, a time for turning on the color split device increases.

When a time for which the color split device is turned on increases, light efficiency improves. The reset state is processed to be a black state, and the panel is in the black state before displaying the next screen. Accordingly, the amount of leaking light is reduced.

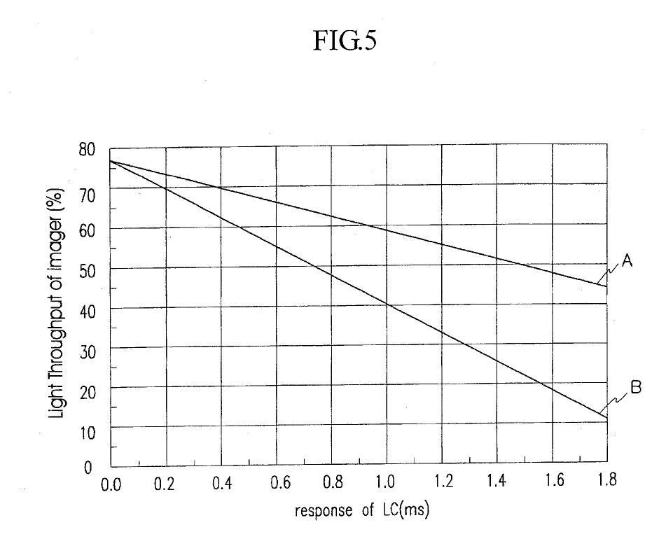

FIG. 5 shows a graph of light being throughput in each mode when a response characteristic of the reflection-type LCD is assumed to be linear.

In FIG. 5, reference “A” denotes a straight line showing the light throughput of the reflection-type LCD driven in the white mode in a normal state, to which an embodiment of the present invention is applied. Reference “B” denotes a straight line showing the light throughput of the reflection-type LCD driven in the white mode in a common normal state.

The light efficiency increase amount is briefly calculated by brightness. In the case of the reflection-type LCD being driven in the white mode in the normal state, the light efficiency increase amount can be briefly calculated to be LT_{NB}/LT_{NW}=(sub frame time−(response time/2))/(sub frame time−response time). Here, NB and NW refer to normally black and normally white, respectively.

When it is assumed that a sub frame reference is 480 Hz (Hertz), a sub frame time is 2.1 ms (milliseconds), and a response time is 0.8 ms, LT_{NB}/LT_{NW} is 1.7/1.3. It is noted that a brightness improvement effect of about 30.8% can be expected.

According to the light efficiency increase amount obtained by a real experiment based on a 150W (Watts) lamp and a 40″ (40 inches measured diagonally) screen, in the reflection-type LCD to which the reset voltage is applied according to the present invention, the increase amount is 409 cd/m² (candela per square meter), and in a reflection-type LCD to which the reset voltage is not applied, the increase amount is 317 cd/m². The increase amount is about 29%, which is similar to the value calculated by the above calculation formula.

The brightness state of the reflection-type LCD driven in the white mode in the normal state, to which the embodiment of the present invention is applied, is compared with the brightness state of the reflection-type LCD driven in the white mode in the common normal state, in the following.

TABLE 1

| Mode | White (cd/m²) | Black (cd/m²) | Contrast Ratio | Note |
|---|---|---|---|---|
| White mode in | 317 | 15.6 | 20.3 | Based on |
| common | | | | 150 W Lamp |
| normal state | | | | 40″ screen |
| White mode in | 409 | 16.8 | 24.4 | |
| normal state, to which the | | | | |
| present | | | | |
| invention is | | | | |
| applied | | | | |

It is noted from Table 1 that white brightness increases 29% from the white brightness of the reflection-type LCD driven in the white mode in the common normal state, that is, 317 (cd/m²), to the white brightness of the reflection-type LCD driven in the white mode in the normal state, to which the present invention is applied, that is 409 (cd/m²). The black brightness increases about 7% from 15.6 (cd/M²) to 16.8 (cd/m²).

As a result, a contrast ratio increases from the contrast ratio of the reflection-type LCD driven in the white mode in the common normal state, that is, 20.3 (cd/m²), to the contrast ratio of the reflection-type LCD driven in the white mode in the normal state, to which the present invention is applied, that is, 24.4 (cd/m²).

The embodiment according to the present invention is applied to the reflection-type LCD driven in the white mode in the normal state. When the embodiment of the present invention is applied to the reflection-type LCD driven in the black mode in the normal mode, light can leak in the reset state.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

It is possible to improve the brightness of an entire system by providing a reset state where the reflection-type LCD driven in the white mode in the normal state among single panel reflection-type LCDs displays an entire screen to be black before displaying the screen. It is possible to reduce an off-time that is a problem in the white mode because a panel that operates in the white mode in the normal state operates like a panel that operates in the black mode in the normal state. Accordingly, it is possible to improve light efficiency and to reduce light leakage.

What is claimed is:

1. A projection system of a reflection-type liquid crystal display, comprising:
an illuminating system selectively transmitting a polarized beam stabilized to be suitable for a wavelength band and a wavelength direction required for displaying a color image in white light emitted by a light source;
a color splitting device sequentially converting the beam selectively transmitted by said illuminating system into red, green, and blue light;
a polarizing beam splitter transmitting the beam converted by said color splitting device and dividing the beam into an S-polarization beam and a P-polarization beam;
a reflection-type liquid crystal display, being driven in synchronization with said color splitting device after displaying a screen, and where a reset voltage forcibly displaying an entire screen to be black is modulated, said reflection-type liquid crystal display receiving the beam polarized by said polarizing beam splitter and driving liquid crystal of each pixel to thus realize the screen; and
a projection lens system enlarging an image realized by said reflection-type liquid crystal display and projecting the image to the screen.

2. The projection system of claim 1, said reflection-type liquid crystal display displays a black screen before displaying a screen by a reset voltage to increase a turn-on time of said color split device.

3. The projection system of claim 1, said reflection-type liquid crystal display, to which a reset voltage of at least a saturation voltage is applied, displays a reset state and a display state.

4. A projection method of a reflection-type liquid crystal display, the method comprising:
(a) selectively transmitting a polarized beam stabilized to be suitable for a wavelength band and a wavelength direction required for displaying a color image in white light emitted by a light source;
(b) sequentially converting the beam, selectively transmitted in said step (a), into red, green, an blue light and dividing said converted light into an S-polarization beam and a P-polarization beam;
(c) receiving the beam, polarized in said step (b), and driving liquid crystal for each pixel to thus realize a screen by said reflection-type liquid crystal display, and enlarging the thus realized image and projecting the enlarged image to the screen through a projection lens system; and
(d) applying a reset voltage to said reflection-type liquid crystal display and forcibly displaying an entire screen to be black before displaying the next screen when a screen is displayed in said step (c).

5. The projection method of claim 4, said reset voltage, applied to said reflection-type liquid crystal display in said step (d), being at least a saturation voltage to accommodate said reflection-type liquid crystal display to display a reset state and a display state after an initial state.

6. The projection method of claim 4, said reset voltage being applied to said reflection-type liquid crystal display in said step (d) controlling a time spent on converting the beam into the red, green, and blue lights in said step (b).

7. The projection method of claim 1, further comprising of applying an excess current to a common electrode of said reflection-type liquid crystal display where said reset voltage forcibly displaying an entire screen to be black is modulated.

8. A projection method of a reflection-type liquid crystal display, the method comprising:
selectively transmitting a polarized beam stabilized to be suitable for a wavelength band and a wavelength direction required for displaying a color image in white light;
sequentially converting the beam, selectively transmitted in said step of selectively transmitting the polarized beam, into a first color light, second color light, and third color light and dividing said converted light into an S-polarization beam and a P-polarization beam;
receiving the beam, polarized in said step of sequentially converting the beam, and driving liquid crystal for each pixel to realize a screen, and enlarging the realized image and projecting the enlarged image to the screen; and
applying a reset voltage to said reflection-type liquid crystal display and forcibly displaying an entire screen to be black before displaying the next screen when a screen is displayed in the step of receiving the beam and projecting the enlarged image to the screen.

9. The projection method of claim 8, said reset voltage, applied to said reflection-type liquid crystal display, being at least a saturation voltage to accommodate said reflection-type liquid crystal display to display a reset state and a display state after an initial state.

10. The projection method of claim 8, said reset voltage being applied to said reflection-type liquid crystal display, controlling a time spent on converting the beam into the first color light, second color light, and third color light in said step of sequentially converting the beam.

11. The projection method of claim 10, further comprising of applying an excess current to a common electrode of said reflection-type liquid crystal display in said step of applying the reset voltage to display the entire screen to be black.

12. A projection system of a reflection-type liquid crystal display, comprising:
a color splitting device sequentially converting a selectively transmitted beam of a white light into red, green, and blue light;
a polarizing beam splitter transmitting the beam converted by said color splitting device and dividing the beam into an S-polarization beam and a P-polarization beam; and
a reflection-type liquid crystal display, being driven in synchronization with said color splitting device after displaying a screen, and where a reset voltage forcibly displaying an entire screen to be black is modulated, said reflection-type liquid crystal display receiving the beam polarized by said polarizing beam splitter and driving liquid crystal of each pixel to realize the screen.

13. The projection system of claim 12, said reflection-type liquid crystal display displays a black screen before displaying a screen by a reset voltage to increase a turn-on time of said color split device.

14. The projection system of claim 12, said reflection-type liquid crystal display, to which a reset voltage of at least a saturation voltage is applied, displays a reset state and a display state.

15. The projection system of claim 13, said reflection-type liquid crystal display, to which a reset voltage of at least a saturation voltage is applied, displays a reset state and a display state.

16. The projection system of claim 15, said reflection-type liquid crystal display comprising of a liquid crystal on silicon panel.

17. A projection method of a reflection-type liquid crystal display, the method comprising:
sequentially converting a selectively transmitted beam of a white light into red, green, an blue light and dividing said converted light into an S-polarization beam and a P-polarization beam;
receiving the beam, polarized in said step of sequentially converting a selectively transmitted beam, and driving liquid crystal for each pixel to realize a screen;
enlarging the realized image and projecting the enlarged image to the screen; and
applying a reset voltage to said reflection-type liquid crystal display and forcibly displaying an entire screen to be black before displaying the next screen when the screen is displayed.

18. The projection method of claim 17, said reset voltage, applied to said reflection-type liquid crystal display, being at least a saturation voltage to accommodate said reflection-type liquid crystal display to display a reset state and a display state after an initial state.

19. The projection method of claim 17, said reset voltage being applied to said reflection-type liquid crystal display, controlling a time spent on converting the beam into the red, green, and blue lights in said step of sequentially converting the beam.

20. The projection method of claim 18, said reset voltage being applied to said reflection-type liquid crystal display, controlling a time spent on converting the beam into the red, green, and blue lights in said step of sequentially converting the beam.
